(19) United States
(12) Patent Application Publication
(10) Pub. No.: US 2010/0008828 A1
(43) Pub. Date: Jan. 14, 2010

(54) Well plate seal structure

(76) Inventor: Bambi Lyn Cahilly, Wrightwood, CA (US)

Correspondence Address: THEODORE J. BIELEN JR.;BIELEN, LAMPE, & THOEMING, 1390 WILLOW PASS ROAD, SUITE 1020, CONCORD, CA, 94520, US

(21) Appl. No.: 12/216,860

(22) Filed: Jul. 11, 2008

(51) Int. Cl. B01L 9/00

(52) U.S. Cl. 422/104

(57) ABSTRACT

A cover for a laboratory sample holding device having at least first and second surfaces. The film of material having adhesive or sealing agent on one side is able to adhere to the laboratory sample holding device. A flange extends from the film and is rotatable relative to the film. The flange also includes an adhesive surface for mounting the cover to the laboratory sample holding device.

### BACKGROUND OF THE INVENTION

The present invention relates to a novel and useful cover for a laboratory sample holding device.

Laboratory devices are often employed to hold samples for testing in medical, scientific, and other applications. A typical sample holding device is known as a well plate or microtitre plate. Such plates include a plurality of wells which extend downwardly from an upper surface. Each of the wells receives a sample of a particular substance being tested, treated and the like.

In order to prevent the evaporation and interaction with the surrounding environment, the wells of the plate are covered with a metallic, plastic-like or similar material which may include an adhesive. Such covers are often pierceable by a hypodermic needle, pipette tip, or other device to allow access to particular wells without opening other wells in the well plate.

In the past, covers for well plates have been proposed. For example, U.S. Pat. No. 6,136,273 shows a closure device for a well plate in which a flexible cover having protruding hollow caps fit into the individual wells in the sealing process.

U.S. Pat. No. 5,882,922 describes a lid for a well plate in which gas diffusion into and out of the assembly is controlled.

U.S. Pat. Nos. 5,858,770, 5,961,926, 6,251,662, and 6,426,215 illustrates sealing films for well plates which engage the well plate through the use of adhesives and other means.

United States Patent Application Publication 2003/0044971 teaches a microorganism culture plate having a splash guard that attaches to the upper rim of the plate to prevent liquid media from leaking from the plate.

U.S. Pat. No. 5,972,694 shows a multi-well plate in which the upper and lower chambers are each separated by a microporous membrane.

U.S. Pat. Nos. 5,928,858, Des. 477,416, and well as United States Patent Application Publication 2002/0141906, and WIPO Publication WO 02/078844 propose laboratory sample holding devices in which films or stickers are used to mark portions of the device to identify certain areas therewithin.

A cover for a laboratory sample holding device which permits the easy identification of the device in any storage configuration would be a notable advance in the scientific field.

### BRIEF SUMMARY OF THE INVENTION

In accordance with the present invention a novel and useful cover for a laboratory sample holding device is herein provided.

The cover of the present invention utilizes a film of material having a first side and a second side. The second side of the film includes an adhesive material positioned thereupon to permit the connection of the film to a first surface of the sample holding device. The first side of the film is exposed to the outside environment relative to the sample holding device. Film material may be constructed of any suitable material such as a polymeric plastic, and may be transparent, translucent, opaque, as the need requires. In addition, the film may include markings to indicate the position of certain areas of the laboratory sample holding device. With respect to a well plate, markings may indicate the individual wells located below the film when the film is in place on such well plate.

The film includes a flange extending from the film. The flange includes a first side and a second side. The second side of the flange possesses an adhesive material or heat sealing film which allows the flange to adhere to the laboratory sample holding device. The flange and the film are connected such that rotation between these two elements is permitted and the film is adhered to a first side of the laboratory sample holding device, while the flange adheres to a second surface of the laboratory sample holding device. Thus, the film, which may include well identifying markings, is viewable from one angle while the flange extending from the film and rotated relative to the film is viewable from another angle. The flange may include identifying indicia on its first side and be constructed of material which allows markings from a marking implement. Further, the flange may be separable from the film and remain on the second surface of the laboratory sample holding device if the film is removed from the first surface thereof.

It may be apparent that a novel and useful cover for a laboratory sample holding device has been hereinabove described.

It is therefore an object of the present invention to provide a cover for a laboratory sample holding device which includes two parts movable relative to one another and which may be applied to separate surfaces of a laboratory sample holding device in one step.

Another object of the present invention is to provide a cover for a laboratory sample holding device having a film which protects a well or wells of the device and a flange which is rotatable relative to the film and may be separated therefrom.

A further object of the present invention is to provide a cover for a laboratory sample holding device which employs a cover having a film and a flange, the latter including indicia or is capable of being marked by a writing implement.

Another object of the present invention is to provide a cover for a laboratory sample holding device which includes a portion that may be color coded to aid in the identification of the laboratory sample holding device when the same is stored with or without similar devices.

Another object of the present invention is to provide a cover for a well plate which includes a film having markings for the individual wells of the well plate and a rotatable flap which adheres to the side surface of the well plate, which includes indicia or is able to accept indicia which identifies the well plate or the contents therein.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a top plan view of the cover of the present invention showing separation from a protector sheet at its lower left hand portion.

FIG. 2 is a side elevational view of a well plate with the cover of the present invention exploded therefrom prior to positioning thereupon.

FIG. 3 is a side elevational view of the well plate of FIG. 2 with the device of the present invention in place and the film being partially removed from the top surface of the well plate.

FIG. 4 is a side elevational view of the cover of the present invention in place on a well plate being marked by a writing implement.

For a better understanding of the invention reference is made to the following detailed description of the preferred embodiments thereof which should be referenced to the prior described drawings.

### DETAILED DESCRIPTION OF THE PREFERRED EMBODIMENTS OF THE INVENTION

Various aspects of the present invention will evolve from the following detailed description of the preferred embodiments thereof which should be taken in conjunction with the prior delineated drawings.

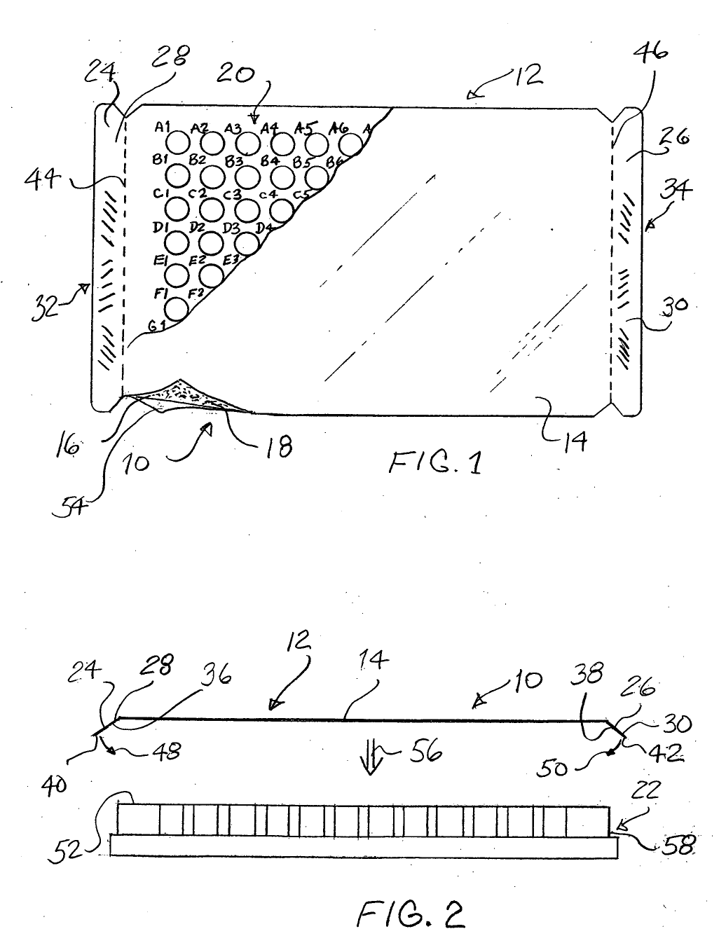

An embodiment of the invention as a whole is depicted in the drawings by reference character 10. Cover 10 is provided with a film or sheet of material 12 which may be metallic, plastic or similar material. Film 12 may be formed of multiple layers. Film 12 includes a first side 14 and an opposite second side 16. Second side 16 includes an adhesive coating 18, shown partially in FIG. 1. Film 12 may be constructed of any suitable material such as polymeric plastic and the like. Film 12 may be transparent, translucent, or opaque as needed, relative to the application of cover 10. As depicted in FIG. 1, film 12 is constructed of translucent material. Also, imprinted positioning markings 20 are partially illustrated in FIG. 1 to indicate that side 14 of film 12 is intended to be aligned with a particular laboratory sample holding device. In the present embodiment, the sample holding device is exemplified by well plate 22, shown in FIG. 2.

Flanges 24 and 26 extend from film 12. Flanges 24 and 26 may be formed of the same material as film or sheet 12. However, surfaces 28 and 30 of flanges 24 and 26, respectively, include identifying indicia 32 and 34, respectively. Such identifying indicia may entail the form of characters, color, color combinations, symbols, and the like, which may be applied before or after adhesion of cover 10 to a laboratory sample holding device. Flange surface 28 and 30 also include adhesive coatings 36 and 38 on surfaces 40 and 42 thereof respectively, FIG. 2. With further reference to FIG. 1, it may be apparent that connection seams 44 and 46 lie between film 12 and flanges 24 and 26, respectively. Seams 44 and 46 are shown in the form a weekend portion such as perforations and permit the rotation of flanges 24 and 26 relative to film 12. However, seams 44 and 46 may simply take the form of fold lines after rotation of flanges 24 and 26 relative to film 12. Such rotation is possible since film 12 and flanges 24 and 26 are formed of a flexible material. Directional arrows 48 and 50, FIG. 2, show the rotation of flanges 24 and 26 relative to film 12.

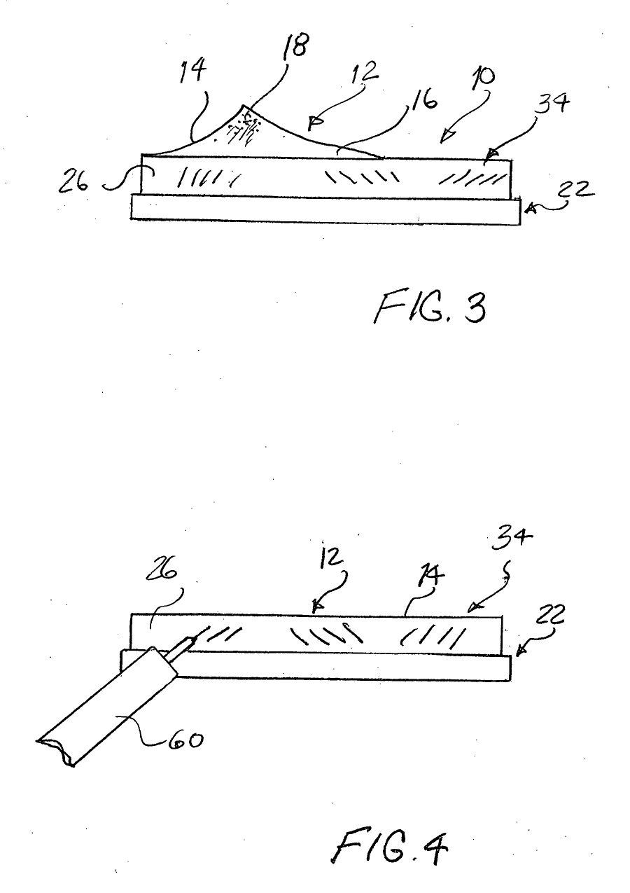

In operation, cover 10 is placed over well plate 22, FIG. 2, and lowered to the top portion 52, thereof, following removal of release sheet 54 so that adhesive layer 18, found on second side 16 of film 12, engages top portion 52. It should be noted that release sheet 54 may be back scored to provide portions of release sheet 54 on flanges 24 and 26. After removal of such release sheet 54 portions from flanges 24 and 26, flanges 24 and 26 may be rotated into adhesion with 58 of well plate 22 of FIG. 2 directional arrows 48 and 50. Directional arrow 56, FIG. 2, indicates such movement of cover 10. FIG. 3 illustrates the placement of cover 10 on well plate 22 and also shows the separation of flange 26 from film 12 along connection seam 46. As may be observed, the complete removal of film 12 from well plate 22 would leave flange 26 adhering to side 58 of well plate 22. Needless to say, flange 24 is also capable of adhering to endless side 58 of well plate 22 and is separable from film 12. FIG. 4 illustrates the fact that indicia 34 on flange 26 may be applied by marking implement 60. However, it should be noted that indicia 34, and or indicia 32 on flanges 26 and 24, respectively may be pre-marked, embossed, or applied in other ways. Moreover, the material of flanges 24 and 26 may be predetermined in order to accept the markings from marking implement 60 in many cases.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A cover for a laboratory sample holding device having at least first and second surfaces,
comprising:
a. a film of material, said film of material including a first side and a second side, said second side of said film including an adhesive material positioned thereon;
b. a flange extending from said film, said flange including a first side and a second side, said second side of said flange including an adhesive material; and
c. a connection between said flange and said film, said connection, said connection permitting the rotation of said flange relative to said film, said film and said flange second surfaces being mounted to the first and second surfaces, respectfully, of the laboratory sample holding device.

2. The cover of claim 1 in which said first surface of said film includes indicia.

3. The cover of claim 1 in which said first surface of said flange includes indicia.

4. The cover of claim 3 in which said first surface of said film includes indicia.

5. The cover of claim 1 in which said first surface of said flange is constructed to accept markings from a marking implement.

6. The cover of claim 5 in which said first surface of said film includes indicia.

7. The cover of claim 5 in which said first surface of said flange includes indicia.

8. The cover of claim 7 in which said first surface of said film includes indicia.

9. The cover of claim 1 in which said flange is separable from said film along said connection between said film and said flange.

10. The cover of claim 9 in which said first surface of said film includes indicia.

11. The cover of claim 9 in which said first surface of said flange includes indicia.

12. The cover of claim 11 in which said first surface of said film includes indicia.

13. The cover of claim 9 in which said first surface of said flange is constructed to accept markings from a marking implement.

14. The cover of claim 13 in which said first surface of said film includes indicia.

15. The cover of claim 13 in which said first surface of said flange includes indicia.

16. The cover of claim 15 in which said first surface of said film includes indicia.

17. The cover of claim 1 in which said connection between said film and said flange comprises a foldable portion.

18. The cover of claim 1 in which said connection between said film and said flange comprises a weakened portion.
